(19) United States
(12) Patent Application Publication
(10) Pub. No.: US 2004/0033877 A1
(43) Pub. Date: Feb. 19, 2004

(54) Methods of creating a playhouse from a cardboard box

(76) Inventor: Ruth E. Muehlmeier, Oconomowoc, WI (US)

Correspondence Address: Donald J. Ersler, 725 Garvens Avenue, Brookfield, WI, 53005, US

(21) Appl. No.: 10/222,682

(22) Filed: Aug. 17, 2002

(51) Int. Cl. B31B 1/00

(52) U.S. Cl. 493/480; 493/959

(57) ABSTRACT

There are at least three methods of creating a playhouse from a cardboard box. A first method includes a covering material and a cardboard box with a playhouse printed on the outside of the box. Identification of the product and company name are printed on the covering material. The covering material is removed to disclose the playhouse design. A second method includes attachable paper with a playhouse design printed thereupon. Identification of the product and company name are printed on the outside of the box. The attachable paper is affixed to an outside of the box. A third method includes a cardboard box with a playhouse design, the identification of a product and company name printed on the outside of the box, and preferably a complementary playhouse design on an inside of the box.

### BACKGROUND OF THE INVENTION

1. Field of the Invention

The present invention relates generally to children's playhouses and more specifically to methods of creating a playhouse from a cardboard box to enhance the value of a product contained in the cardboard box.

2. Discussion of the Prior Art

There are numerous playhouses in the art that are created from specially cut and decorated cardboard material. However, it appears that the art lacks any methods of creating a playhouse from a cardboard box used to retain a product. The value of a product sold in a cardboard box may be enhanced, if the cardboard box could be used as a child's playhouse, after the product is removed.

Accordingly, there is a clearly felt need in the art for methods of creating a playhouse from a cardboard box by printing a playhouse on a box and covering thereof with a covering material; including playhouse attachable paper in the box that may be applied thereto; and by printing a playhouse design and the normal company identification on the outside of the box.

### SUMMARY OF THE INVENTION

The present invention provides methods of creating a playhouse from a cardboard box. A first method of creating a playhouse from a cardboard box includes a covering material and a cardboard box with a playhouse design printed on the outside of the cardboard box. A complementary playhouse design may be printed on an inside of the cardboard box. Identification of the product and company name are printed on the covering material. The covering material is preferably at least one peel-off lamination sheet. The at least one peel-off lamination sheet is sufficiently large to cover the printed playhouse design. After a consumer purchases the product inside the cardboard box. The consumer removes the at least one peel-off lamination to reveal the playhouse design. The covering material could be a covering band. The covering band would be substituted for the at least one peel-off lamination. The covering band would be slipped over the cardboard box.

A second method of creating a playhouse from a cardboard box includes attachable paper (such as contact paper) with the design of a playhouse printed thereupon. Identification of the product and company name are printed on the outside of the box. A complementary playhouse design may be printed on an inside of the box. The adhesive cover is removed from the attachable paper and placed on the exterior of the cardboard box.

A third method of creating a playhouse from a cardboard box includes a cardboard box with printing on at least one side thereof. A playhouse design is preferably printed on at least three surfaces of an outside of the cardboard box, and identification of the product and company name are printed on the remaining surfaces. A complementary playhouse design may be printed on an inside of the box. The playhouse for all three methods preferably include windows, doors, vents and other openings that may be cut to give thereof functionality.

Accordingly, it is an object of the present invention to provide a method of creating a playhouse from a cardboard box by printing a playhouse on a box and covering thereof with a cover material having product identification and a company name printed thereupon.

It is a further object of the present invention to provide a method of creating a playhouse from a cardboard box by including attachable paper having a playhouse design printed thereupon for attachment to the cardboard box.

Finally, it is another object of the present invention to provide a method of creating a playhouse from a cardboard box by printing a playhouse design on at least three surfaces and printing product identification and company name on the remaining surfaces of an outside of the box.

These and additional objects, advantages, features and benefits of the present invention will become apparent from the following specification.

### BRIEF DESCRIPTION OF THE DRAWINGS

FIG. 1 is a perspective view of a cardboard box with a playhouse design printed on an outside thereof and surrounded by peel-off lamination sheets with product identification and company name printed thereupon.

FIG. 1a is a perspective view of a covering band with product identification and company name printed thereupon.

FIG. 2 is a perspective view of a cardboard box and a roll of attachable paper with a playhouse design printed thereupon placed inside the cardboard box.

FIG. 3 is a perspective view of a partially unrolled roll of attachable paper having an adhesive cover partially peeled off thereof in accordance with the present invention.

FIG. 4 is a perspective view of a cardboard box with attachable paper partially applied thereto.

FIG. 5a is a view of an outside of a flattened cardboard box with a playhouse design, product identification and a company name printed thereupon.

FIG. 5b is a view of an inside of a flattened cardboard box with a complementary playhouse design printed thereupon.

FIG. 6a is a front perspective view of a cardboard box disclosing a design of a playhouse printed thereupon.

FIG. 6b is a rear perspective view of a cardboard box with product identification and company name printed thereupon.

FIG. 7 is a perspective view of a cardboard with a design of a playhouse having a window, door, and other cutouts.

FIG. 8a is a perspective view of a cardboard box with a weighted objected secured to a rear surface thereof.

FIG. 8b is a side view of a cardboard box that is secured to a cupboard door.

### DETAILED DESCRIPTION OF THE PREFERRED EMBODIMENTS

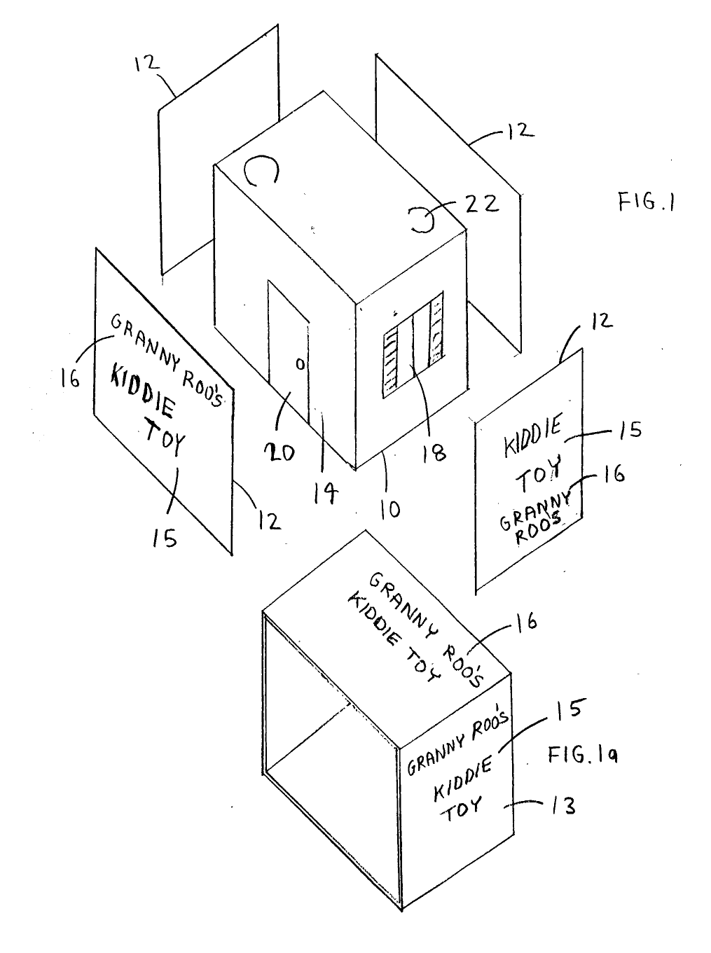

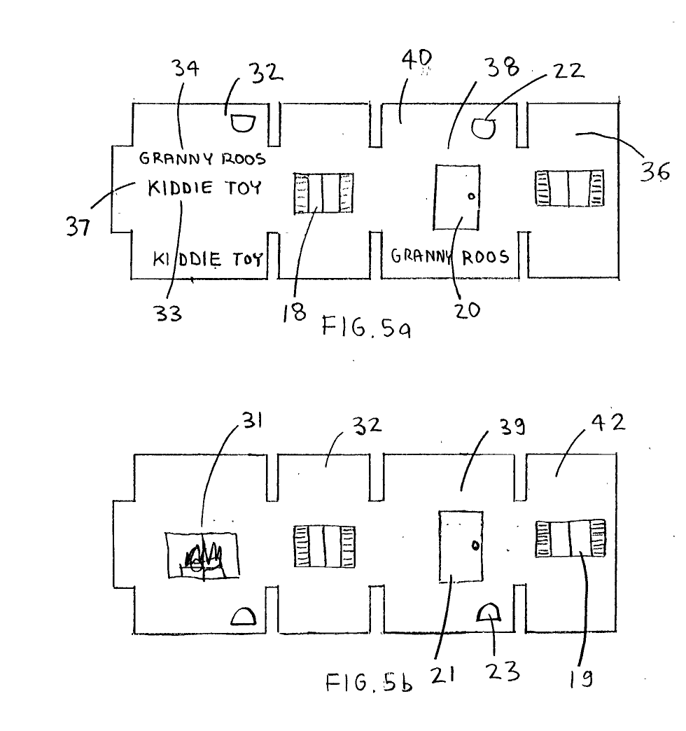

With reference now to the drawings, and particularly to figure 1, there is shown a perspective view of a cardboard box 10 surrounded by at least one peel-off lamination sheet 12. A first method of creating a playhouse from a cardboard box 10 includes the at least one peel-off lamination sheet 12 and the cardboard box 10 with a playhouse design 14 printed on the outside thereof. A complementary playhouse design may be printed on an inside of the cardboard box 10 as shown in FIG. 5b. However, other types of removable sheets or added sheets may also be used besides the peel-off lamination sheet. Identification of the product name 15 and company name 16 are printed on the at least one peel-off lamination sheet 12.

The at least one peel-off lamination sheet 12 is preferably attached to the cardboard box 10 during manufacture. The at least one peel-off lamination sheet 12 may be a single sheet applied to one surface of the cardboard box 10 or a single lamination sheet 12 which is applied to a flattened cardboard box 10, before it is folded. The at least one lamination sheet 12 is sufficiently large to cover the printed playhouse design 16. After a consumer purchases the product inside the cardboard box 10; the consumer removes the at least one peel-off lamination sheet 12 to reveal a printed playhouse design 16.

FIG. 1a discloses an alternative covering material to the at least one peel-off lamination sheet 12. A covering band 13 is slipped over the cardboard box 10. Identification of the product name 15 and the company name 16 are printed on the covering band 13. The covering band 13 covers the playhouse design 14 and may be removed by any suitable method. The covering band 13 may cover the length or width of the cardboard box 10. With reference to FIG. 7, the playhouse design 16 preferably includes windows 18, doors 20, vents 22 and other openings that may be cut to give the cardboard box 10 functionality.

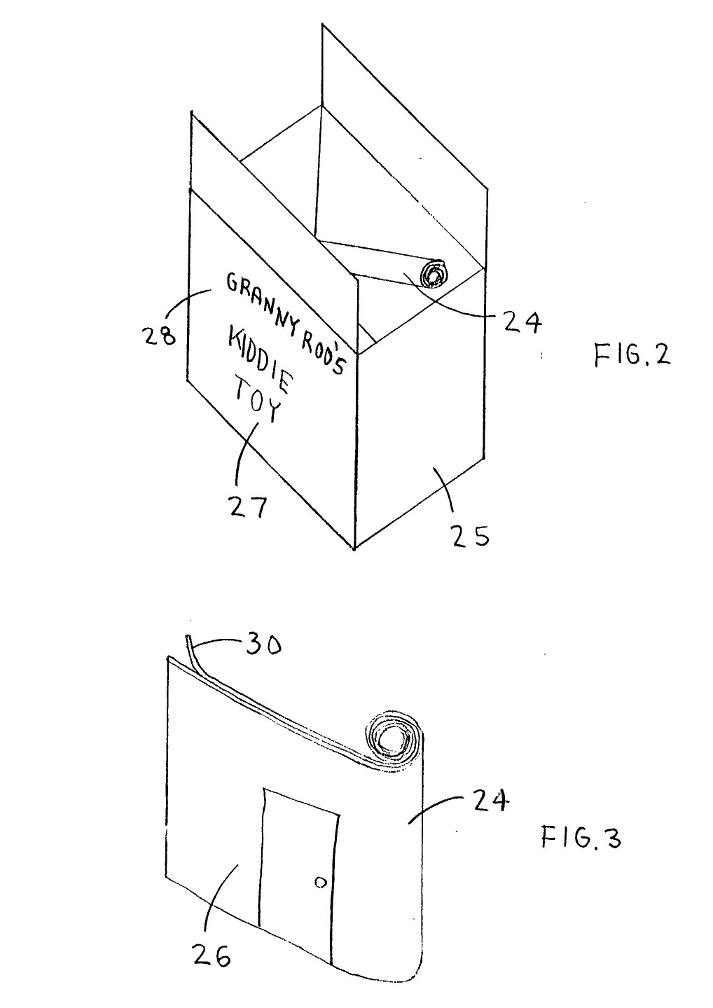

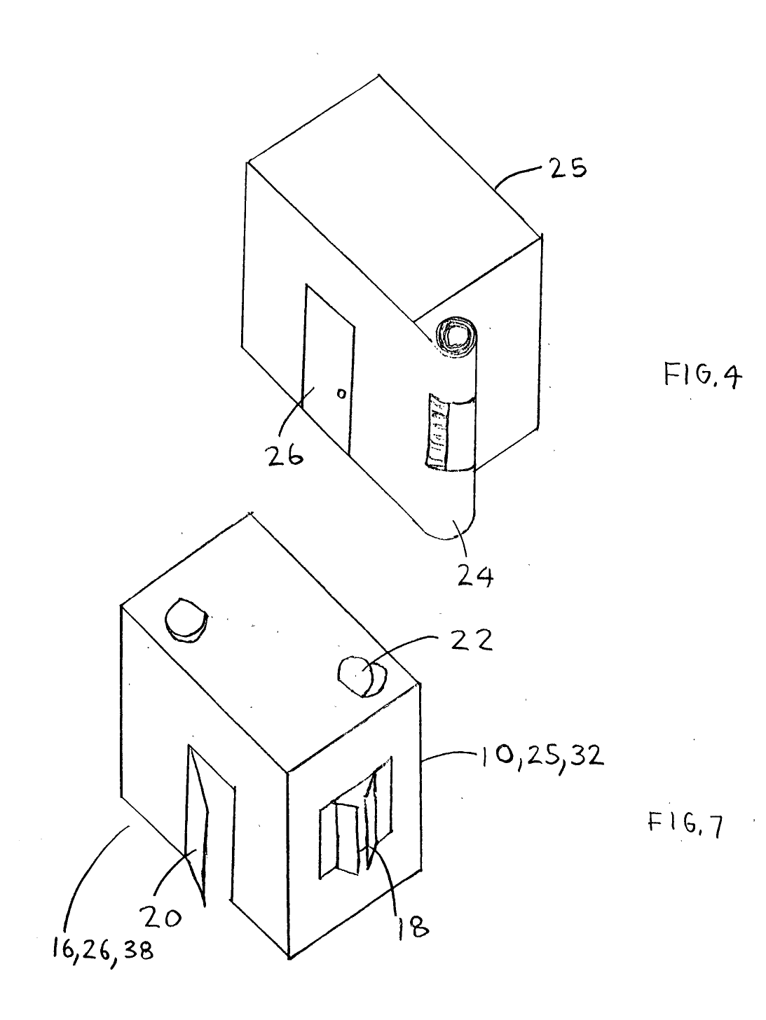

With reference to FIGS. 2-4, a second method of creating a playhouse from a cardboard box includes attachable paper 24 with a playhouse design 26 printed thereupon included with a cardboard box 25. Identification of the product 27 and company name 28 are printed on the outside of the cardboard box 25. A complementary playhouse design may be printed on an inside of the cardboard box 25 as shown in FIG. 5b. An adhesive cover 30 of the attachable paper 24 is removed and the attachable paper 24 is attached to an exterior of the cardboard box 25. The playhouse design 26 preferably includes windows 18, doors 20, vents 22 and other openings that may be cut into the cardboard box 10, 25 to give the playhouse functionality. A further feature would include an order form that illustrates attachable paper with other playhouse designs, which a consumer may order. The attachable paper 24 may be in the form of a roll or at least one sheet.

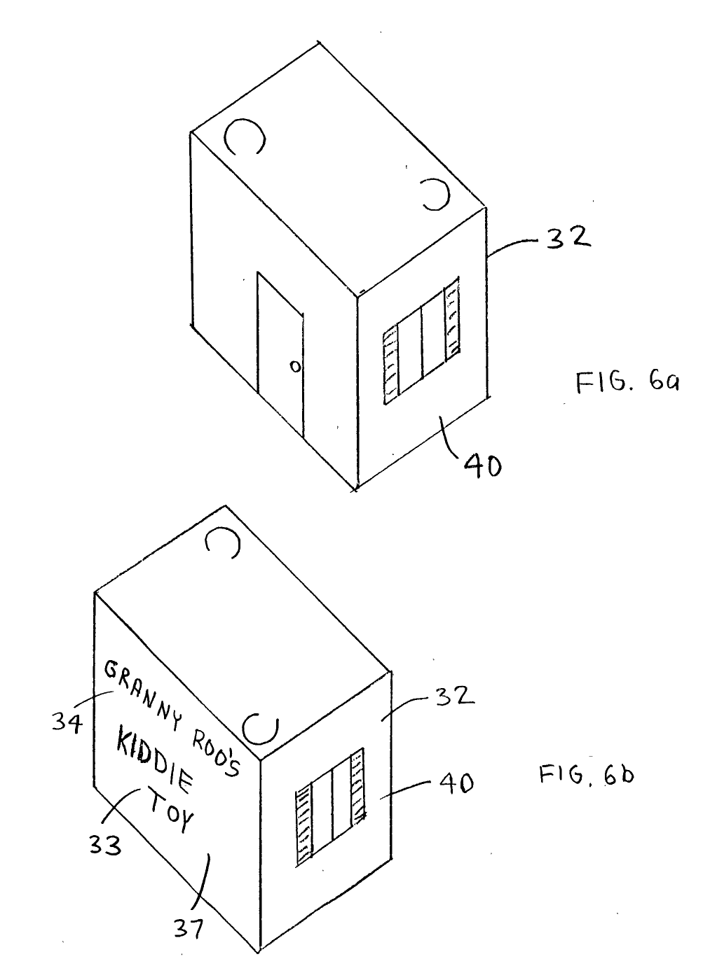

With reference to FIGS. 5a-6b, a third method of creating a playhouse from a cardboard box includes a cardboard box 32 with printing at least one side thereof. A playhouse design 38 is preferably printed on at least three surfaces of an outside 40 of the cardboard box 32 and identification of the product 33 and company name 34 are printed on the remaining surfaces of the cardboard box 32. FIG. 5a and 6b show the identification of the product 33 and the company name 34 printed on a rear surface 37 of the cardboard box 32. A complementary playhouse design 39 is preferably printed on an inside 42 of the cardboard box 32 during manufacture. The playhouse design 38 preferably includes windows 18, doors 20, vents 22 and other openings that may be cut to give thereof functionality. The complementary playhouse design 39 includes windows 19, doors 21 and vents 23, which are aligned with the windows 18, doors 20 and vents 22. Other items may be added to the complementary playhouse design 39 such as a fireplace 31.

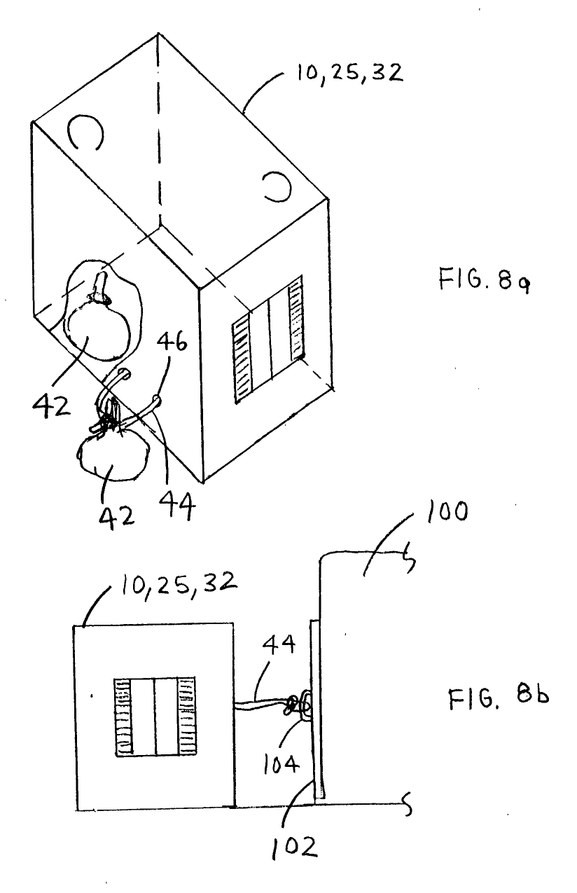

With reference to FIG. 8a, a weighted object 42 may be attached to or placed in the cardboard box 10, 25, 32 to prevent a child from moving or tipping thereof and possibly incurring injury. A rope 44 may be inserted through a couple of holes 46 formed in a rear surface of the cardboard box 10, 25, 32. The rope 44 is secured to the weighted object 42, such as a sandbag. With reference to FIG. 8b, a cardboard box 10, 25, 32 is secured to a cupboard 100 to prevent thereof from being moved by a child. The rope 44 is preferably inserted through the couple of holes 46 in the side of the cardboard box 10, 25, 32 and secured to at least one door handle 104 of a cupboard door 102. However, other methods of anchoring the cardboard box 10, 25, 32 may also be used.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of creating a playhouse from a cardboard box, comprising the steps of:
creating a playhouse design on an outside surface of a cardboard box, said cardboard box containing a product;
covering said playhouse design with a covering material;
creating identification of the company selling the product in at least one place on said at least one removable sheet; and
removing said at least one removable after the purchase of the product contained within said cardboard box.

2. The method of creating a playhouse from a cardboard box of claim 1, further comprising the step of:
creating identification of the name of the product on said at said covering material.

3. The method of creating a playhouse from a cardboard box of claim 1, further comprising the step of:
providing said covering material as at least one removable sheet.

4. The method of creating a playhouse from a cardboard box of claim 3, further comprising the step of:
providing said at least one removable sheet as a peel-off lamination sheet.

5. The method of creating a playhouse from a cardboard box of claim 1, further comprising the step of:
providing said covering material as a covering band.

6. The method of creating a playhouse from a cardboard box of claim 1, further comprising the step of:
including at least one door and one window in said playhouse design.

7. The method of creating a playhouse from a cardboard box of claim 1, further comprising the step of:
securing said playhouse such that thereof does not move.

8. The method of creating a playhouse from a cardboard box of claim 1, further comprising the step of:
printing a complementary playhouse on an inside surface of said cardboard box.

9. A method of creating a playhouse from a cardboard box, comprising the steps of:
creating a playhouse design on at least one sheet of attachable paper to form at least one sheet of playhouse attachable paper;
providing a cardboard box, said cardboard box containing a product and said at least one sheet of playhouse attachable paper;
removing said at least one sheet of playhouse attachable paper from said cardboard box after the purchase of the product contained within said cardboard box; and
attaching said at least one sheet of playhouse attachable paper to an outside surface of said cardboard box.

10. The method of creating a playhouse from a cardboard box of claim 9, further comprising the step of:
including at least one door and one window in said playhouse design.

11. The method of creating a playhouse from a cardboard box of claim 9, further comprising the step of:
securing said playhouse such that thereof does not move.

12. The method of creating a playhouse from a cardboard box of claim 9, further comprising the step of:
offering at least one sheet of playhouse attachable paper with a playhouse design that is different from that included in said cardboard box.

13. The method of creating a playhouse from a cardboard box of claim 9, further comprising the step of:
printing a complementary playhouse on an inside surface of said cardboard box.

14. A method of creating a playhouse from a cardboard box, comprising the steps of:
printing a playhouse design on at least three surfaces of an outside of a cardboard box;
printing identification of the company name on the remaining surfaces of said outside of said cardboard box; and
assembling said cardboard box such that said outside of said cardboard box is exposed.

15. The method of creating a playhouse from a cardboard box of claim 14, further comprising the step of:
printing a complementary playhouse design on an inside of said cardboard box.

16. The method of creating a playhouse from a cardboard box of claim 14, further comprising the step of:
including at least one door and one window in said playhouse design.

17. The method of creating a playhouse from a cardboard box of claim 12, further comprising the step of:
including at least one door and one window in said complementary playhouse design.

18. The method of creating a playhouse from a cardboard box of claim 12, further comprising the step of:
securing said playhouse such that thereof does not move.
